(19) United States
(12) Patent Application Publication
(10) Pub. No.: US 2008/0243596 A1
(43) Pub. Date: Oct. 2, 2008

(54) Methods for advertising with personalized content and naming and systems thereof

(75) Inventor: Gregg R. Olin, Fariport, NY (US)

Correspondence Address: NIXON PEABODY LLP - PATENT GROUP, 1100 CLINTON SQUARE, ROCHESTER, NY, 14604, US

(73) Assignee: Mind Optics LLC, Fairport, NY (US)

(21) Appl. No.: 12/080,039

(22) Filed: Mar. 31, 2008

Related U.S. Application Data
(60) Provisional application No. 60/920,622, filed on Mar. 29, 2007.

(51) Int. Cl. G06Q 30/00

(52) U.S. Cl. 705/10; 705/14

(57) ABSTRACT

A method, computer readable medium and system for personalized advertising includes retrieving at least one type and kind of advertisement based on preference information obtained from a consumer. The retrieved advertisement comprises at least one personification clip identifying the consumer by name integrated with general advertising content. The retrieved advertisement is output to the consumer for display.

This application claims the benefit of U.S. Provisional Application No. 60/920,622, filed Mar. 29, 2007, which is hereby incorporated by reference in its entirety.

### FIELD OF THE INVENTION

The present invention relates to methods and systems for advertising and, more particularly, to methods for advertising with personalized content and naming and systems thereof.

### BACKGROUND

Traditional advertising on the Internet has evolved from simple banner advertisements and text links to search-engine related, context-sensitive advertisements and product placement rich-media advertisements included in other forms of consumer desired content. For example, services providing free video if the consumer is willing to watch an advertisement before viewing the free content.

With the vast number of users and viral user growth exhibited on free user contributed content websites, these websites have faced the daunting task of how to capitalize on advertising revenue while not alienating the user base and experience mass user attrition.

Attempts have been made to generate more directed consumer advertising videos, but even these attempts merely provide generic greetings to the consumer. For example, these attempts try to be personal by saying “Hi there” or addressing the consumer by some other general generic greeting, but have no real connection to the consumer's particular advertising preferences. Others attempts have tried to introduce a form of personalized marketing by directing product advertisements based upon search inquiries entered by users.

### SUMMARY

A method for personalized advertising in accordance with embodiments of the present invention includes retrieving at least one type and kind of advertisement based on preference information obtained from a consumer. The retrieved advertisement comprises at least one personification clip identifying the consumer by name integrated with general advertising content. The retrieved advertisement is output to the consumer for display.

A computer readable medium having stored thereon instructions for personalized advertising in accordance with other embodiments of the present invention includes retrieving at least one type and kind of advertisement based on preference information obtained from a consumer. The retrieved advertisement comprises at least one personification clip identifying the consumer by name integrated with general advertising content. The retrieved advertisement is output to the consumer for display.

A system for personalized advertising in accordance with other embodiments of the present invention includes a retrieval system and an output system. The retrieval system retrieves at least one type and kind of advertisement based on preference information obtained from a consumer. The retrieved advertisement comprises at least one personification clip identifying the consumer by name integrated with general advertising content. The output system outputs the retrieved advertisement to the consumer for display.

The present invention provides a number of advantages including providing the consumer with unabated control over whether or not they wish to see an advertisement, as well as determining what types and kinds of advertisements the consumer would like to see. As a result, the present invention provides advertisers with an attentive audience for advertisements for the particular type and kind of products and services they are interested in. Additionally, the advertisements are much more appealing to consumers and have a much higher chance of successfully driving sales because the advertisements are provided to the consumers through the use of celebrities or other endorsers preferred by these consumers who personally address the consumer by name during the advertisements.

### BRIEF DESCRIPTION OF THE DRAWINGS

FIG. 1 is a block diagram of a system for advertising with personalized content and naming in accordance with embodiments of the present invention; and

FIG. 2 is a flowchart of a method for obtaining data on one or more types and kinds of advertising preferred by a consumer;

FIG. 3 is a flowchart of a method for creating advertisements with personalized content and naming; and

FIG. 4 is a flowchart of method for retrieving and displaying advertisements with personalized content and naming.

### DETAILED DESCRIPTION

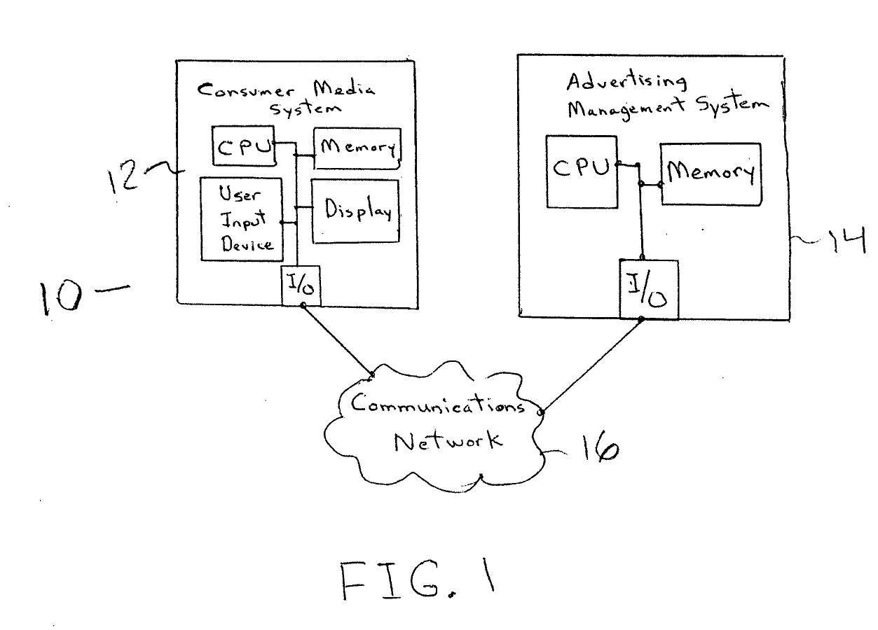

A system 10 for generating and providing advertising with personalized content and naming in accordance with embodiments of the present invention is illustrated in FIG. 1. Personalized content also is referred to as personalization and personalized naming also is referred to as personification herein. The system 10 includes a consumer media system 12, an advertising management system 14, and a communications network 16, although the system can include other types and numbers of components, devices, systems and/or servers in other configurations. The present invention provides a number of advantages including providing a more effective, efficient, and easy method to personalize advertising for a consumer.

Referring to FIG. 1, the consumer media system 12 enables a consumer or operator to opt-in and identify advertising which is of interest and to receive and also to receive and listen and/or watch personalized advertising, although other types and numbers of operations could be performed on the consumer media system 12. In this particular embodiment, the consumer media system 12 is a mobile phone, although other numbers and types of systems and devices which are able to display or output video and audio content, could be used, such as a phone or blackberry iTV, TV, PDA, mobile phone, iPod, or other computing system by way of example only.

The consumer media system 12 includes a central processing unit (CPU) or processor, a memory, an interface system, a user input system, and a display system which are coupled together by a bus or other link, although the consumer media system 12 can comprise other numbers and types of components and systems in other configurations. The processor in the consumer media system 12 executes a program of stored instructions for one or more aspects of the present invention as described and illustrated herein, although the processor could execute other types of programmed instructions. The memory the consumer media system 12 stores these programmed instructions for one or more aspects of the present invention as described herein, although some or all of the programmed instructions could be stored and/or executed elsewhere. A variety of different types of memory storage devices, such as a random access memory (RAM) or a read only memory (ROM) in the system or a floppy disk, hard disk, CD ROM, or other computer readable medium which is read from and/or written to by a magnetic, optical, or other reading and/or writing system that is coupled to one of the processor, can be used for the memory. The interface system in the consumer media system 12 is used to operatively couple and communicate between the consumer media system 12 and an advertising management system 14 over the communications network 16, although other numbers and types of connections to other devices, systems, and servers could be used.

The user input device in the consumer media system 12 is used to input data, such as detailed information on the types and brands of advertising which are of interested and the consumer's favorite celebrities, although other types of data and information could be entered. The user input device comprises a computer keyboard and a computer mouse, although other types and numbers of user input devices can be used. The display system in the consumer media system 12 is used to show data and information to the consumer, such as the personalized advertising which may include endorsements from one or more of the consumer's favorite celebrities. The display system comprises a computer display screen, such as a CRT or LCD screen with speakers by way of example only, and a speaker system to provide audio, although other types and numbers of displays could be used.

The advertising management system 14 obtains and manages personalized advertising information from consumers and provides personalized advertising, such as endorsements from one of the consumer's favorite celebrities for a type and brand of product which is of interest, although other types and numbers of computing systems, in other locations, with other capabilities and functions could be used. The advertising management system 14 includes a central processing unit (CPU) or processor, a memory, and an interface system which are coupled together by a bus or other link, although other numbers and types of each of the components and other configurations and locations for the components can be used. The processor in the advertising management system 14 executes a program of stored instructions for one or more aspects of the present invention as described herein. The memory stores these programmed instructions for one or more aspects of the present invention as described herein, although some or all of the programmed instructions could be stored and/or executed elsewhere. A variety of different types of memory storage devices, such as a random access memory (RAM) or a read only memory (ROM) in the system or a floppy disk, hard disk, CD ROM, DVD ROM, or other computer readable medium which is read from and/or written to by a magnetic, optical, or other reading and/or writing system that is coupled to the processor, can be used. The interface system in the advertising management system 14 is used to operatively couple and communicate between the advertising management system 14 and the consumer media system 12, although other numbers and types of connections to other devices, systems, and servers could be used.

The communications network 16 comprises the Internet, although other types and numbers of communication systems, such as a direct connection, a local area network, a wide area network, modems and phone lines, e-mails, and/or wireless communication technology each having their own communications protocols, in other configurations could be used.

Although an example of embodiments of the consumer media system 12 and advertising management system 14 are described and illustrated herein, each could be implemented on any suitable device, system, or server. It is to be understood that the devices, systems, and servers of the exemplary embodiments are for exemplary purposes, as many variations of the specific hardware and software used to implement the exemplary embodiments are possible, as will be appreciated by those skilled in the relevant art(s).

Furthermore, each of the devices, systems, and servers of the present invention may be conveniently implemented using one or more general purpose computer systems, microprocessors, digital signal processors, micro-controllers, and the like, programmed according to the teachings of the present invention as described and illustrated herein, as will be appreciated by those skilled in the computer and software arts.

In addition, two or more computing devices, systems, or servers can be substituted for any one of the devices, systems, or servers in any embodiment of the present invention. Accordingly, principles and advantages of distributed processing, such as redundancy, replication, and the like, also can be implemented, as desired, to increase the robustness and performance the devices and systems of the exemplary embodiments. The present invention may also be implemented on one or more of any devices, systems or servers that extend across any network using any suitable interface mechanisms and communications technologies including, for example telecommunications in any suitable form (e.g., voice, modem, and the like), wireless communications media, wireless communications networks, cellular communications networks, G3 communications networks, Public Switched Telephone Network (PSTNs), Packet Data Networks (PDNs), the Internet, intranets, a combination thereof, and the like.

The present invention may also be embodied as a computer readable medium having instructions stored thereon for personalized advertising as described herein, which when executed by a processor, causes the processor to carry out the steps necessary to implement the methods of the present invention as described and illustrated herein.

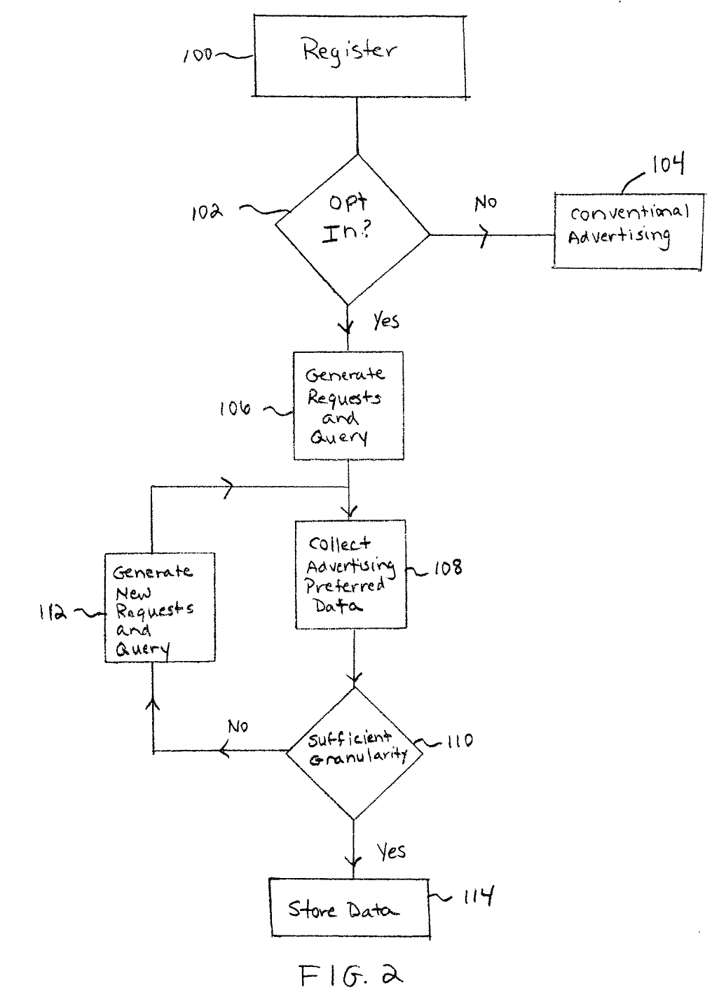

A method for obtaining data on one or more types and kinds of advertising preferred by a consumer will now be described with reference to FIGS. 1-2, although other methods for obtaining this data can be used. In step 100, a consumer at the consumer media system 12 registers or opens an account on a website, such as one which is maintained at the advertising management system 14 by way of example only, although other manners for registering consumer media system 12 could be used.

In step 102, a determination is made on whether the consumer at the consumer media system 12 has opted-in to obtain the advertising with personalized content and naming, although the consumer can be queried about other types of opt-ins relating to the provided advertising. For example, the consumer could opt-in to view advertisements configured for another consumer or group. If the consumer at the consumer media system 12 has not opted-in to obtain the advertising with personalized content and naming, then the No branch is taken to step 104. In step 104, the consumer media system 12 continues to receive advertising in conventional formats. If the consumer at the consumer media system 12 has opted-in to obtain the advertising with personalized content and naming, then the Yes branch is taken to step 106.

In step 106, the advertising management system 14 generates a series of consumer surveys in which topical categories on types and kinds of advertising are presented to the consumer on the display of the consumer media system 12 for selection, although other manners for obtaining preferences for the types and kinds of advertising preferred by the consumer can be used. By way of example only, the advertising management system 14 could generate requests and query the consumer using with fill-in forms or drop-down selections on the display of the consumer media system 12. Additionally, by way of example only, the types of advertising include broadcast commercials, infomercials, and movie trailers and the kinds of advertising include rich multi-media, videos with associated audio, podcasts, or other forms of digital video with associated audio, although other advertising preferences can be queried and collected

In step 108, the consumer uses the user input device in the consumer media system 12 to respond to the requests about preferences for types and kinds of advertising which are transmitted to and collected by the advertising management system 14, although other manners for obtaining information about the preferences of the consumer for types and kinds of advertising can be used.

While requesting and obtaining this information on preferences on types and kinds of advertising in steps 106 and 108, the advertising management system 14 also requests and obtains from the consumer non-personal demographic and statistical data which can be used by the advertising management system 14 as the basis for identifying pricing and target market opportunities for different advertisers. The advertising management system 14 also requests and obtains from the consumer information on a preferred method or methods of delivering the types and kinds of advertising preferred by the consumer, such as via a mobile phone, PDA, email, online, TV, or iTV by way of example only and other types of data could be collected. Further, the advertising management system 14 requests and obtains from the consumer information on dates and times when the consumer prefers to receive different types and kinds of advertising. By way of example only, the consumer may prefer to receive advertising for seasonal products and/or services at one or more certain dates and times. Even further, the advertising management system 14 requests and obtains information on the favorite celebrity or celebrities for the consumer, although information on other types of endorsers that the consumer views favorable also can be requested and obtained. With the identification of the favorite celebrities or other endorsers for the consumer, the advertising management system 14 can obtain and distribute the particular type and kind of advertising the consumer at the consumer media system 12 prefers with a personal endorsement naming the consumer from one or more of the favorite celebrities endorsing the product or service being offered. As described in greater detail below, the advertising video with associated audio content is created and stored at the advertising management system 14 and in this embodiment comprises a directed personal message by a celebrity that has been previously screened as a favorite celebrity of the particular consumer. In this particular embodiment, the additional information which is queried and obtained relates to consumer non-personal demographic and statistical data, one or more preferred methods of delivering advertising, one or more preferred dates and times for receiving advertising, and preferred celebrity or other endorser, although other types and amounts of information can be queried and obtained to further refine the provided advertising.

In step 110, the advertising management system 14 determines if the collected information on the preferences on types and kinds of advertising preferred by the consumer at the consumer media system 12 has sufficient granularity. The particular level of granularity can be set and stored in the advertising management system 14 and can vary based on the particular application, although other manners for establishing and determining if a sufficient level of granularity has been achieved can be used. The particular level of granularity relates to whether the collected information has met enough criteria to assemble or match personalized advertisements (e.g. the preferred celebrity endorser, the consumer's name, the consumer's gender, and product type) to the consumer as desired or needed. If the advertising management system 14 determines the collected information on the preferences on types and kinds of advertising preferred by the consumer at the consumer media system 12 does not have sufficient granularity, then the No branch is taken to step 112.

In step 112, the advertising management system 14 generates another series of consumer surveys with more granularity on options of types and kinds of advertising which are presented to the consumer on the display of the consumer media system 12 for selection and then proceeds to step 108 as described above, although other manners for obtaining preferences for the types and kinds of advertising preferred by the consumer can be used. In this step, the consumer also may be queried to obtain or refine other additional information, such as determining which of the identified celebrities or other endorsers the consumer prefers for which particular types and kinds of advertisements by way of example only. This iterative process can be repeated several times to narrow the selections of the consumer and ultimately provide advertising which is much more targeted and thus of much more interest to the consumer at consumer media system 12. By way of example, only, this iterative process can narrow the advertisements down to general categories or granularity of advertising for products, such as sporting goods and clothes, to more specific categories, such as golf and shirts, to even more specific categories, such as golf balls and t-shirts.

If in step 110 the advertising management system 14 determines the collected information on the preferences on types and kinds of advertising preferred by the consumer at the consumer media system 12 does have sufficient granularity, then the Yes branch is taken to step 114. In step 114, the collected information on the preferences for types and kinds of advertising preferred by the consumer at the consumer media system 12 along with the other collected information are associated with a registered profile for the consumer and stored at the advertising management system 14 for retrieval and use in personalized advertising, although other manners and locations for storing the information can be used.

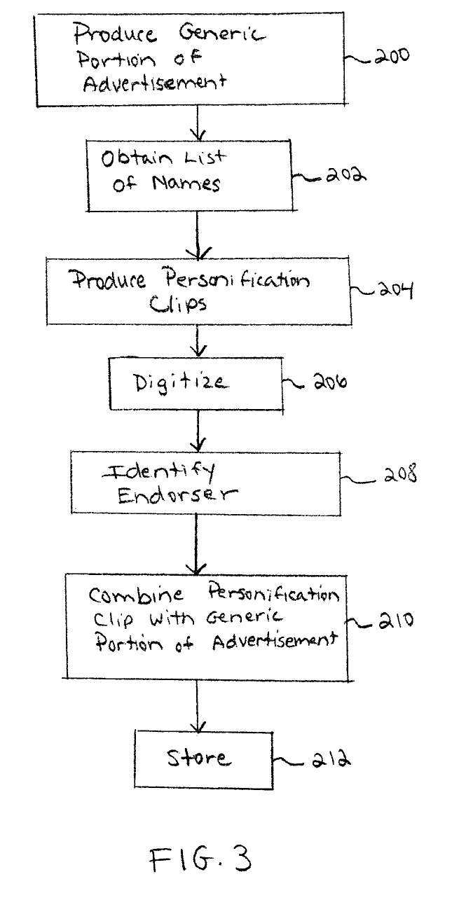

Referring to FIGS. 1 and 3, a method for creating advertisements with personalized content and naming in accordance with embodiments of the present invention is illustrated, although other manners for creating advertisements can be used. In step 200, for each product or service which is being advertised, a video with associated audio of a generic or fixed portion of an advertisement is produced with one or more spots designated for the insertion of personification clips, i.e. a personalized video content with associated audio.

In step 202, the advertising management system 14 retrieves from memory a list of common male and female first names for the particular location to generate the personification clips, although other manners for obtaining the names can be used. By way of example only, the names for each personification clip could be obtained by user input as each personification clip is produced. The lists of names stored by the advertising management system 14 are rank ordered by frequency of distribution in the target demographic of interest while combining phonetically equivalent names, such as Jon and John, although other manners for ranking and organizing the list of names can be used.

In step 204, a video with associated audio of a personification clip for each of the obtained names is produced using one or more of the celebrities or other endorsers on file or contracted by an agency creating such advertisements, although other manners for creating the personification clips can be used and other numbers of personification clips can be produced. In this particular embodiment, the audio is provided by a celebrity, although other types of endorsers could be used, such as animated characters, a synthetic voice, a simulated celebrity voice, or other type of voice. The personification clips which are produced can be made before, during, or after the video with associated audio of the generic or fixed portion of an advertisement is produced. These personification clips are designed for use in one or more of the designated spots in the generic or fixed portion of the advertisement.

In step 206, a digitized or digital pre-master of the video and associated audio the video with associated audio of the generic or fixed portion of the advertisement for each product or service and the video with associated audio of the personification clip for each of the obtained names is produced by the advertising management system 14 if not already in digital format, although other formats can be used and other types and numbers of system can produce the digitized or digital pre-master video with associated audio.

In step 208, the advertising management system 14 identifies the celebrity or other endorser that the consumer views favorably from the stored data for the registered consumer, although other manners for obtaining this information can be used. Next, the advertising management system 14 obtains the personification clip or clips from memory produced by the celebrities or other endorsers identified for the consumer which use the name of the consumer, although other manners for identifying and obtaining personification clips can be used.

In step 210, the advertising management system 14 combines each obtained personification clip into the one or more designated spots in the video with associated audio of the generic or fixed portion of the advertisement for each of the products and services identified to be of interest to the consumer to produce the advertising with personalized content and naming, although other manners for forming the advertising with personalized content and naming can be used. By way of example only, the personification clip may precede a generic or fixed portion of a video and associated audio advertisement for a sports car with the consumer's favorite celebrity speaking into the camera and directly addressing the consumer by first name. In this example, assuming the consumer's name is John, the resulting combined advertisement might say, “John, you really ought to get behind the wheel of this sports car, it is sooo you . . . ” and then a seamless splice to the generic portion of the advertisement, and then maybe even a post-personification clip with the celebrity looking into the camera saying . . . “catch you at the dealership, John.”

By way of example only, another manner for creating a personalized advertisement comprises having an automated selection of a personification clip or clips via a matching index on a given account associated with the consumer at the consumer media system 12. The selected personification clip or clips would be downloaded and digitally assembled in the designated spots in the generic or fixed video and associated audio advertising by the advertising management system 14 in real-time for viewing on the display of the consumer media system 12. This embodiment would reduce overall storage requirements because the resulting advertisement could be immediately download for display and there would be no need for storage of pre-made advertisements in this embodiment.

In step 212, the advertising management system 14 stores each of the combined video and associated audio with the personalized content and naming for use on the consumer media system 12 when requested, although the combined video with associated audio can be stored in other locations and manners. Additionally, as explained in the alternative embodiment discussed above, this storage step is unnecessary when the selected personification clip or clips is/are downloaded and digitally assembled in the designated spots in the generic or fixed video and associated audio advertisement by the advertising management system 14 in real-time for viewing on the display of the consumer media system 12.

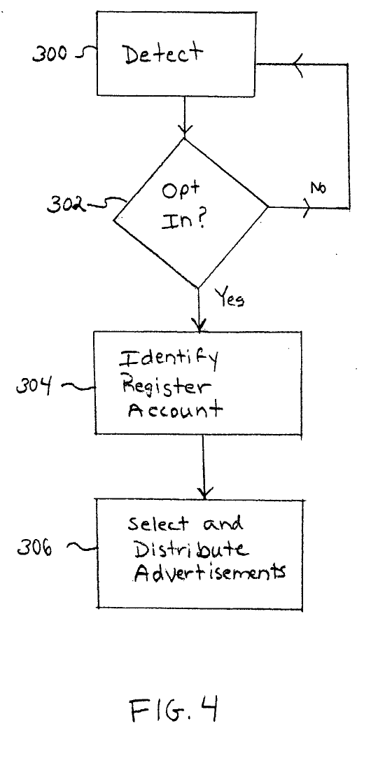

Referring to FIGS. 1 and 4, method for retrieving and displaying advertisements with personalized content and naming in accordance with embodiments of the present invention is illustrated, although other manners for retrieving and displaying advertisements with personalized content and naming can be used. In step 300, the consumer media system 12 notifies the advertising management system 14 that it is available, although other manners for determining that the consumer media system 12 is available.

In step 302, the advertising management system 14 determines if the consumer media system 12 has opted in for advertising with personalized content and naming. If the consumer media system 14 has not opted in, then the No branch is taken back to step 300 where the advertising management system 14 looks for other consumer media systems that may be available to receive personalized advertising. The consumer media system 12 continues to receive advertising in a conventional format. If the consumer media system 14 has opted in, then the Yes branch is taken back to step 304.

In step 304, the advertising management system 14 identifies the registered account with the advertising with the personalized content and naming for the consumer media system 12 that has opted in, although other manners for identifying the stored information can be used. The advertising with the personalized content and naming is obtained from the stored library of personalized videos with associated audio for each of the consumers, although other manners for obtaining the personalized advertisements can be used, such as generating the personalized advertisements in real time

In step 306, the advertising management system 14 selects and distributes one or more of the advertisements with the personalized content and naming to the consumer media system 12 for display, although other manners for distributing and displaying the advertisements can be used. The advertising management system 14 controls the distribution to the consumer media system 12 based on the collected information about the consumer, such as the type and content of advertisements, the date and time preferred for advertisements, and the format of the advertisements for display. As discussed earlier, the consumer media systems can comprise a variety of different types of systems, such as a phone, laptop computer, PDA, television, or standalone computer by way of example only, where the video with any associated audio is output to the consumer.

Accordingly, this method of video with associated audio advertising production and distribution simulates personal messaging to the consumer from the celebrity. For example, a consumer's favorite celebrity looking directly into the camera can address all consumers named “John” with one video with associated audio, and all consumers named Bill, with a slight modification to a digital video with associated audio production of the same advertisement. These easily editable personalized messages can then be electronically distributed to a consumer at a consumer media system 12 that corresponds to the selected type and kind of advertising with the endorsement from the consumer's favorite celebrity. In much the same way you can receive personalized email from a company because they know your identity, these personalized videos with associated audio can be delivered to the proper consumer with the correct personalized message. This type of advertising will provide an increased buy-rate for the products and services being advertised because the consumer has received a personalized celebrity endorsement from someone that individual sees as a trusted or admired source. The present invention also can be used with audio advertisements when the distribution method is considered point-to-point or where the identity of the listener is known at the time of transmission.

Having thus described the basic concept of the invention, it will be rather apparent to those skilled in the art that the foregoing detailed disclosure is intended to be presented by way of example only, and is not limiting. Various alterations, improvements, and modifications will occur and are intended to those skilled in the art, though not expressly stated herein. These alterations, improvements, and modifications are intended to be suggested hereby, and are within the spirit and scope of the invention. Additionally, the recited order of processing elements or sequences, or the use of numbers, letters, or other designations therefore, is not intended to limit the claimed processes to any order except as may be specified in the claims. Accordingly, the invention is limited only by the following claims and equivalents thereto.

What is claimed is:

1. A method for personalized advertising, the method comprising:
retrieving at least one type and kind of advertisement based on preference information obtained from a consumer, the retrieved advertisement comprises at least one personification clip identifying the consumer by name integrated with general advertising content; and
outputting the retrieved advertisement to the consumer for display.

2. The method as set forth in claim 1 further comprising identifying when a consumer is on a consumer media system which can receive at least one type and kind of advertisement which corresponds with the preference information for the consumer.

3. The method as set forth in claim 1 further comprising obtaining from the consumer the preference information for the type and kind of advertisements preferred by the customer.

4. The method as set forth in claim 1 wherein the obtaining further comprising obtaining at least one endorser the consumer prefers, wherein the general content and the at least one personification clip identifying the consumer by name is from the at least one endorser the consumer prefers.

5. The method as set forth in claim 1 wherein the obtaining further comprises obtaining at least one of non-personal demographic data and statistical data from the consumer, wherein at least one characteristic of the retrieved advertisement is adjusted based on the at least one of non-personal demographic data and statistical data from the consumer.

6. The method as set forth in claim 1 wherein the obtaining further comprises obtaining at least one of a preferred method of delivering the retrieved advertisement to the consumer and at least one preferred date and time for providing the retrieved advertisement to the consumer, wherein the outputting further comprises delivering the retrieved advertisement to the consumer for the outputting based on at least one of the preferred method of delivering the retrieved advertisement to the consumer and the at least one preferred date and time for providing the retrieved advertisement.

7. The method as set forth in claim 3 wherein the obtaining from the consumer the preference information for the type and kind of advertisements preferred by the customer comprises an iterative process to obtain the preference information.

8. The method as set forth in claim 7 further comprising determining when the preference information has sufficient granularity on at least the type and kind of advertisement preferred by the customer.

9. The method as set forth in claim 1 further comprising generating at least one type and kind of advertisement based on the preference information obtained from the consumer.

10. The method as set forth in claim 9 wherein the generating at least one type and kind of advertisement further comprises:
generating the general advertising content for the at least one type and kind of advertisement;
generating the at least one personification clip identifying the consumer by name; and
integrating the generated at least one personification clip in one or more spots in the generated general advertising content.

11. The method as set forth in claim 10 wherein the integrating the generated at least one personification clip in the one or more spots in the generated general advertising content occurs in substantially real time.

12. A computer readable medium having stored thereon instructions for personalized advertising comprising machine executable code which when executed by at least one processor, causes the processor to perform steps comprising:
retrieving at least one type and kind of advertisement based on preference information obtained from a consumer, the retrieved advertisement comprises at least one personification clip identifying the consumer by name integrated with general advertising content; and
outputting the retrieved advertisement to the consumer.

13. The medium as set forth in claim 12 further comprising identifying when a consumer is on a consumer media system which can receive at least one type and kind of advertisement which corresponds with the preference information for the consumer.

14. The medium as set forth in claim 12 further comprising obtaining from the consumer the preference information for the type and kind of advertisements preferred by the customer.

15. The medium as set forth in claim 12 wherein the obtaining further comprising obtaining at least one endorser the consumer prefers, wherein the general content and the at least one personification clip identifying the consumer by name is from the at least one endorser the consumer prefers.

16. The medium as set forth in claim 12 wherein the obtaining further comprises obtaining at least one of non-personal demographic data and statistical data from the consumer, wherein at least one characteristic of the retrieved advertisement is adjusted based on the at least one of non-personal demographic data and statistical data from the consumer.

17. The medium as set forth in claim 12 wherein the obtaining further comprises obtaining at least one of a preferred method of delivering the retrieved advertisement to the consumer and at least one preferred date and time for providing the retrieved advertisement to the consumer, wherein the outputting further comprises delivering the retrieved advertisement to the consumer for the outputting based on at least one of the preferred method of delivering the retrieved advertisement to the consumer and the at least one preferred date and time for providing the retrieved advertisement.

18. The medium as set forth in claim 14 wherein the obtaining from the consumer the preference information for the type and kind of advertisements preferred by the customer comprises an iterative process to obtain the preference information.

19. The medium as set forth in claim 18 further comprising determining when the preference information has sufficient granularity on at least the type and kind of advertisement preferred by the customer.

20. The medium as set forth in claim 12 further comprising generating at least one type and kind of advertisement based on the preference information obtained from the consumer.

21. The medium as set forth in claim 20 wherein the generating at least one type and kind of advertisement further comprises:
generating the general advertising content for the at least one type and kind of advertisement;
generating the at least one personification clip identifying the consumer by name; and
integrating the generated at least one personification clip in one or more spots in the generated general advertising content.

22. The medium as set forth in claim 21 wherein the integrating the generated at least one personification clip in the one or more spots in the generated general advertising content occurs in substantially real time.

23. A system for personalized advertising, the system comprises:
a retrieval system that retrieves at least one type and kind of advertisement based on preference information obtained from a consumer, the retrieved advertisement comprises at least one personification clip identifying the consumer by name integrated with general advertising content; and
an output system that outputs the retrieved advertisement to the consumer for display.

24. The system as set forth in claim 23 further comprises an identification system that identifies when a consumer is on a consumer media system which can receive at least one type and kind of advertisement which corresponds with the preference information for the consumer.

25. The system as set forth in claim 23 further comprises an information retrieval system that obtains from the consumer the preference information for the type and kind of advertisements preferred by the customer.

26. The system as set forth in claim 23 further comprises:
an information retrieval system that obtains at least one endorser the consumer prefers; and
an advertisement generation system that generates the general content and the at least one personification clip with the at least one endorser the consumer prefers.

27. The system as set forth in claim 23 further comprises:
an information retrieval system that obtains at least one of non-personal demographic data and statistical data from the consumer; and
an advertisement generation system that generates the general content and the at least one personification clip based on the at least one of non-personal demographic data and statistical data from the consumer.

28. The system as set forth in claim 23 further comprises an information retrieval system that obtains at least one of a preferred method of delivering the retrieved advertisement to the consumer and at least one preferred date and time for providing the retrieved advertisement to the consumer, wherein the output system delivers the retrieved advertisement to the consumer based on at least one of the preferred method of delivering the retrieved advertisement to the consumer and the at least one preferred date and time for providing the retrieved advertisement.

29. The system as set forth in claim 25 wherein the information retrieval system uses an iterative process to obtain the preference information.

30. The system as set forth in claim 29 further comprises a granularity analysis system that determines when the preference information has sufficient granularity on at least the type and kind of advertisement preferred by the customer.

31. The system as set forth in claim 23 further comprises an advertisement generation system that generates at least one type and kind of advertisement based on the preference information obtained from the consumer.

32. The system as set forth in claim 31 wherein the advertisement generation system generates the general advertising content for the at least one type and kind of advertisement, generates the at least one personification clip identifying the consumer by name, and integrates the generated at least one personification clip in one or more spots in the generated general advertising content.

33. The system as set forth in claim 32 wherein the advertisement generation system integrates the generated at least one personification clip in the one or more spots in the generated general advertising content in substantially real time.
